(19) United States
(12) Patent Application Publication
(10) Pub. No.: US 2022/0053063 A1
(43) Pub. Date: Feb. 17, 2022

(54) RELAY APPARATUS AND NON-TRANSITORY COMPUTER READABLE MEDIUM

(71) Applicant: FUJIFILM BUSINESS INNOVATION CORP., Tokyo (JP)

(72) Inventor: Hironobu NAGAYAMA, Kanagawa (JP)

(73) Assignee: FUJIFILM BUSINESS INNOVATION CORP., Tokyo (JP)

(21) Appl. No.: 17/169,665

(22) Filed: Feb. 8, 2021

(30) Foreign Application Priority Data
Aug. 13, 2020 (JP) 2020-136725

(51) Int. Cl. H04L 29/08

(52) U.S. Cl. CPC H04L 67/28; H04L 67/34

(57) ABSTRACT

A relay apparatus includes a processor configured to inquire of a management apparatus that manages control information used by plural devices whether there is control information that should be downloaded by, among the plural devices, a device whose communication is relayed by the relay apparatus to the management apparatus, for a same model as the device whose communication is relayed.

### CROSS-REFERENCE TO RELATED APPLICATIONS

This application is based on and claims priority under 35 USC 119 from Japanese Patent Application No. 2020-136725 filed Aug. 13, 2020.

### BACKGROUND

### (i) Technical Field

The present disclosure relates to a relay apparatus and a non-transitory computer readable medium.

### (ii) Related Art

In recent years, there has been proposed, in a system for downloading firmware used by each device, a hub server for alleviating the load on a center server that manages firmware used by all devices (for example, see Japanese Unexamined Patent Application Publication No. 2007-213434).

The hub server described in Japanese Unexamined Patent Application Publication No. 2007-213434 is, in order to update firmware used by a device connected to a communication network, connected to a center server that stores firmware used by the device and to the device via the communication network, and downloads the firmware to the device via the communication network. The hub server includes an identification unit and a download unit. The identification unit compares a time at which firmware stored in the hub server is updated and a time at which firmware stored in the center server is updated, and identifies firmware newly registered in the center server. The download unit selects the firmware newly registered in the center server, which is identified by the identification unit, downloads the firmware from the center server, and stores the firmware.

### SUMMARY

Aspects of non-limiting embodiments of the present disclosure relate to providing a relay apparatus and a non-transitory computer readable medium for alleviating, in a system including a management apparatus that manages control information used by all devices and a relay apparatus that relays communication between the management apparatus and each device, the load on a communication line of the relay apparatus, compared to the case where the relay apparatus downloads control information for all types of devices from the management apparatus.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a relay apparatus including a processor configured to inquire of a management apparatus that manages control information used by a plurality of devices whether there is control information that should be downloaded by, among the plurality of devices, a device whose communication is relayed by the relay apparatus to the management apparatus, for a same model as the device whose communication is relayed.

### BRIEF DESCRIPTION OF THE DRAWINGS

An exemplary embodiment of the present disclosure will be described in detail based on the following figures, wherein:

FIG. 1 is a diagram illustrating an example of the configuration of an information processing system according to an exemplary embodiment of the present disclosure;

FIG. 2 is a diagram illustrating an example of the logical configuration of the information processing system illustrated in FIG. 1;

FIG. 3 is a block diagram illustrating an example of a control system of a device;

FIG. 4 is a block diagram illustrating an example of a control system of a management server;

FIG. 5 is a diagram illustrating an example of a communication log information table held by the management server;

FIG. 6 is a diagram illustrating an example of a management information table held by the management server;

FIG. 7 is a block diagram illustrating an example of a control system of a relay server;

FIG. 8 is a diagram illustrating an example of a communication log information table held by the relay server;

FIG. 9 is a diagram illustrating an example of a management information table held by the relay server; and

FIG. 10 is a sequence diagram illustrating an example of the operation of the information processing system.

### DETAILED DESCRIPTION

Hereinafter, an exemplary embodiment of the present disclosure will be described with reference to the drawings. Elements in the drawings that have substantially the same function are given the same reference numeral, and overlapping descriptions thereof are omitted.

### Summary of Exemplary Embodiment

A relay apparatus according to an exemplary embodiment includes a processor configured to inquire of a management apparatus that manages control information used by a plurality of devices whether there is control information that should be downloaded by, among the plurality of devices, a device whose communication is relayed by the relay apparatus to the management apparatus, for a same model as the device whose communication is relayed.

Control information includes firmware, applications, data, and the like. Firmware is a program for causing a device's hardware to operate, and is downloaded to the device and used.

### Exemplary Embodiment

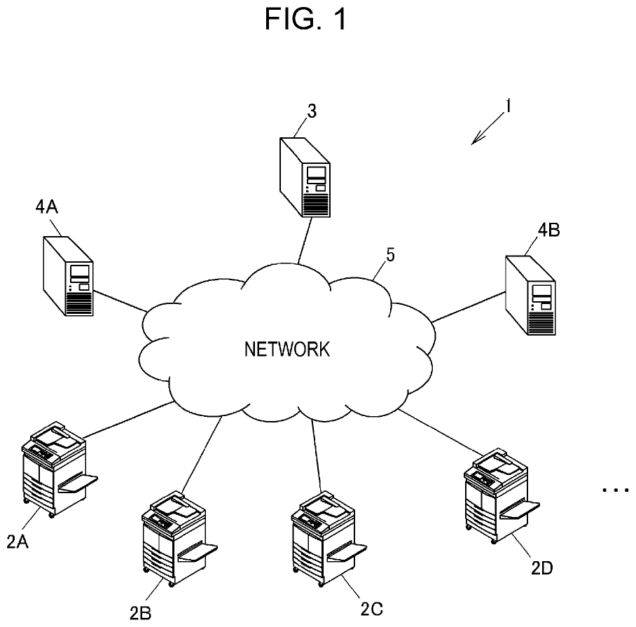

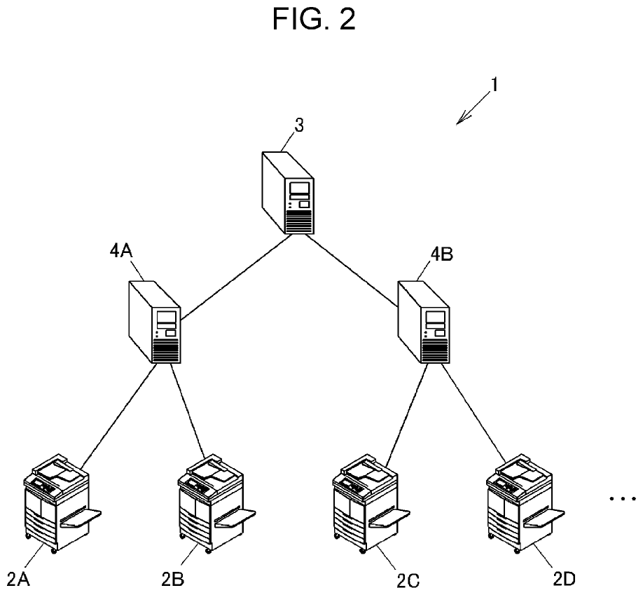

FIG. 1 is a diagram illustrating an example of the configuration of an information processing system according to an exemplary embodiment of the present disclosure. FIG. 2 is a diagram illustrating an example of the logical configuration of the information processing system illustrated in FIG. 1.

An information processing system 1 includes the following, as illustrated in FIG. 1: a plurality of devices 2A, 2B, 2C, 2D, . . . (may also be referred to as “devices 2” when they are collectively referred to); a management server 3, which manages all the devices 2; and relay servers 4A and 4B (may also be referred to as “relay servers 4” when they are collectively referred to), which relay communication between the management server 3 and the devices 2. The devices 2, the management server 3, and the relay servers 4 are connected to each other via a network 5. Note that the number of the relay servers 4 is not limited to two, and may be one, or three or greater. The management server 3 is an example of a management apparatus. The relay servers 4 are an example of a relay apparatus.

All the devices 2A, 2B, 2C, 2D, . . . are connected flat to the management server 3 and the relay servers 4 via the network 5, as illustrated in FIG. 1; however, they have, as the logical structure, a tree structure centered on the management server 3, as illustrated in FIG. 2. That is, the devices 2A and 2B are allocated to be under control of one relay server 4A and are connected to the management server 3 via the relay server 4A. The devices 2C, 2D, . . . are allocated to be under control of the other relay server 4B and are connected to the management server 3 via the relay server 4B.

The devices 2 may be allocated to the relay servers 4 by, for example, the following methods. Note that these methods are not the only possible methods.

### (a) Regional Allocation

On the basis of the position information (such as the Internet Protocol (IP) address, Global Positioning System (GPS) position information, or the like) of the devices 2, devices 2 that are installed at positions regionally close to one relay server 4 are allocated to that relay server 4. According to this method, the communication distance may be prevented from being extremely long, compared to the case of allocation without considering the region.

### (b) Allocation According to the Model of Each Device 2

The devices 2 are allocated by model to the relay servers 4. According to this method, the relay servers 4 may manage fewer types of firmware, compared to the case of allocation without considering the model.

### (c) Allocation so as to Place an Equal Load on the Communication Line

Firmware may be frequently updated, depending on the model or development time of each device 2. This taken into consideration, the devices 2 may be allocated by model or development time so as to have an equal load on the communication line.

The network 5 is a communication network such as the Internet, an intranet, a local area network (LAN), a wide area network (WAN), or the like. For example, the relay servers 4A and 4B may be connected to the devices 2 via respective subnetworks or the like.

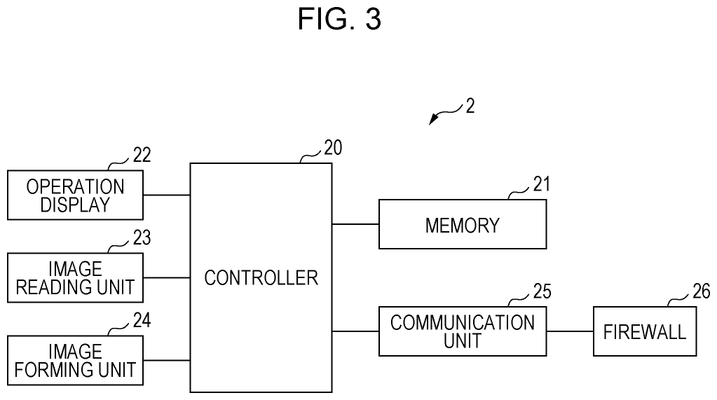

The devices 2 are connected to the network 5 via a firewall 26 (see FIG. 3), which will be described later. The firewall 26 aims to prevent unauthorized access or intrusion from the outside. The firewall 26 is set to allow requests (may also be referred to as inquiries) from the devices 2 to the network 5 and responses to the requests to pass, but not allow requests from the network 5 side to the devices 2 to pass. In response to a command from a user or at a predetermined time, each device 2 inquires of a corresponding one of the relay servers 4 whether there is firmware that should be updated, and if there is such firmware, downloads and updates the firmware.

The management server 3 holds and manages files of firmware (hereinafter may also be referred to as “FW files”) for updating software used by all the devices, such as firmware. Firmware and FW files are examples of control information.

The relay servers 4 allow, in response to inquiries from devices 2 under control thereof, the devices 2 to download FW files, and obtain FW files that should be updated from the management server 3.

### Configuration of Device

FIG. 3 is a block diagram illustrating an example of a control system of each of the devices 2. The device 2 is, for example, a multifunctional peripheral that has the scan function, the print function, the copy function, the email function, and the fax send/receive function. The multifunctional peripheral is an example of an image forming apparatus.

Note that the device 2 may be an image forming apparatus such as a printer or a fax machine. In addition, the device 2 is not limited to an image forming apparatus, and may be an information processing apparatus such as a multi-functional mobile phone (smartphone), a personal computer (PC), or a tablet terminal. In addition, all or some of the devices 2 may be image forming apparatuses.

Each device 2 includes a controller 20, which controls each unit of the device 2. A memory 21, an operation display 22, an image reading unit 23, and an image forming unit 24 are connected to the controller 20, and a communication unit 25 and the like are connected to the controller 20 via the firewall 26 realized by a gateway, a router, and the like.

The controller 20 includes a processor such as a central processing unit (CPU), an interface, and the like. By executing a program stored in the memory 21, the controller 20 periodically (such as at 18:00 every day) accesses a corresponding one of the relay servers 4 to inquire whether there is an FW file that should be updated. If there is such an FW file, the controller 20 downloads the FW file from the relay server 4 as a response to the inquiry, and stores the FW file in the memory 21. If there is no relay server 4 that manages the device 2, the controller 20 inquires of the management server 3. In some cases, the controller 20 may inquire whether there is such an FW file in response to a user command.

In addition, the controller 20 performs a process of updating the FW file stored in the memory 21, and, when the updating process is completed, sends an update completion report to the relay server 4. If there is no relay server 4 that manages the device 2, the controller 20 sends an update completion report to the management server 3.

In addition, the controller 20 receives a job sent from a user terminal (not illustrated) or a job commanded by operating the operation display 22, and executes the job by controlling the image reading unit 23, the image forming unit 24, and the communication unit 25.

The memory 21 includes read-only memory (ROM), random-access memory (RAM), a hard disk drive, and the like, and stores information such as programs and FW files.

The operation display 22 is configured to input and display information. The operation display 22 is, for example, a touchscreen display, and has a configuration in which a touchscreen is arranged on a display such as a liquid crystal display.

The image reading unit 23 includes an automatic paper feeder located on a document glass, and a scanner that optically reads a document image from a document placed on the document glass or from a document sent by the automatic paper feeder.

The image forming unit 24 generates a printed matter by forming an image on paper, which is fed from a paper cassette, by using an electrophotographic system, an inkjet system, or the like.

The communication unit 25 communicates with the relay server 4 via the firewall 26 and the network 5.

### Configuration of Management Server

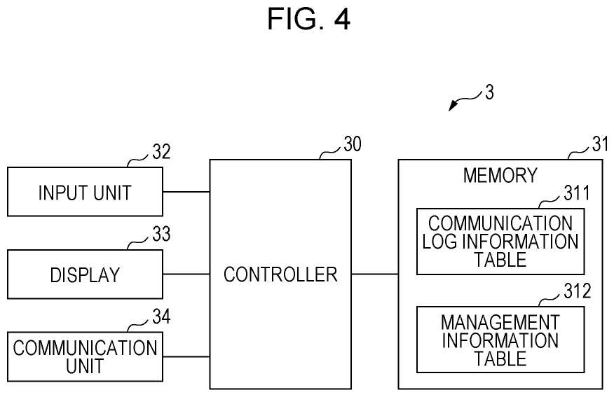

FIG. 4 is a block diagram illustrating an example of a control system of the management server 3. The management server 3 includes a controller 30, which controls each unit of the management server 3. A memory 31, an input unit 32 realized by a keyboard, a mouse, and the like, a display 33 realized by a liquid crystal display or the like, and a communication unit 34 which communicates with the relay servers 4 and the like via the network 5 are connected to the controller 30.

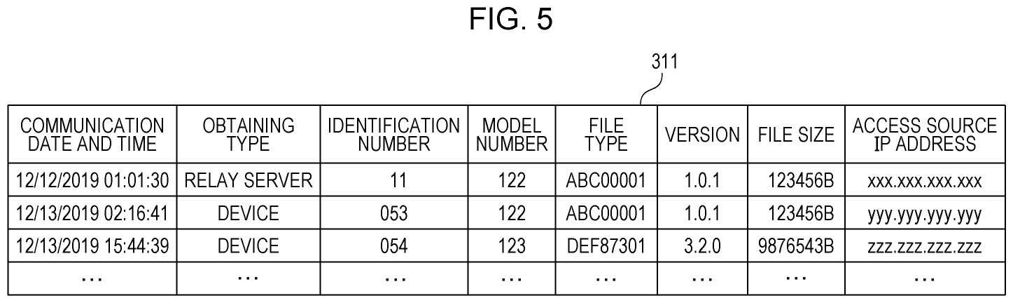

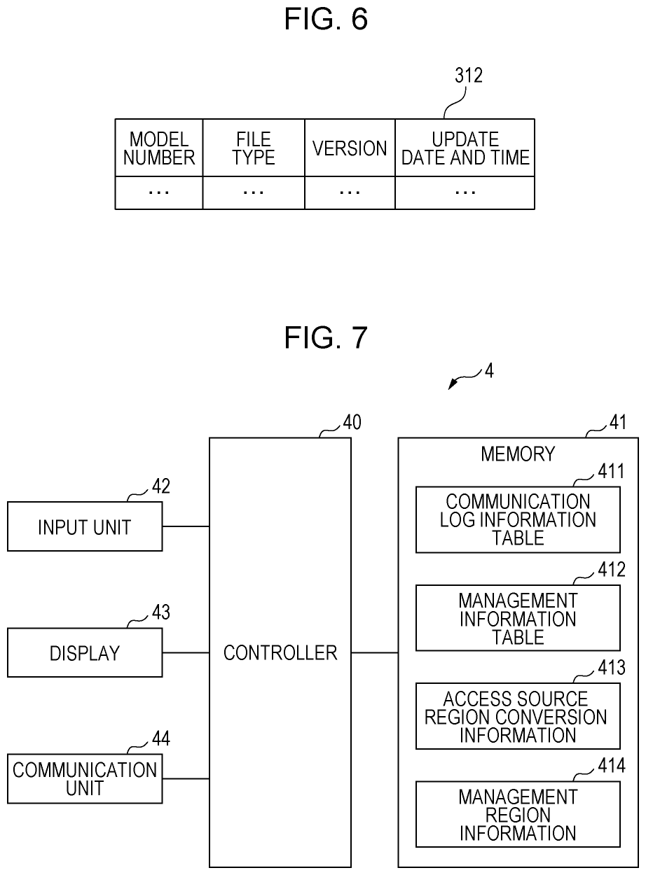

The controller 30 includes a processor such as a CPU, an interface, and the like. By executing a program stored in the memory 31, the controller 30 sends FW files stored in the memory 31 to the devices 2 and the relay servers 4, and records and registers information in a communication log information table 311 (see FIG. 5) and a management information table 312 (see FIG. 6).

The memory 31 includes ROM, RAM, a hard disk drive, and the like, and stores various types of information including programs, FW files, the communication log information table 311 (see FIG. 5), the management information table 312 (see FIG. 6), and device information of all the devices 2. Device information includes an identification number, a model number, an IP address, and the like. The meanings of an identification number and a model number will be described later. Device information may be input by the administrator from the input unit 32, or may be registered by the controller 30 on the basis of access from the relay servers 4 or the devices 2.

FIG. 5 is a diagram illustrating an example of the communication log information table 311 held by the management server 3. The communication log information table 311 includes a plurality of items such as “communication date and time”, “obtaining type”, “identification number”, “model number”, “file type”, “version”, “file size”, and “access source IP address”. Communication log information is information including these items. A model number is an example of information of a model.

In “communication date and time”, the date and time of access is recorded. Depending on when the devices 2 and the relay servers 4 are installed, not only the relay servers 4 but also the devices 2 may access the management server 3. In “obtaining type”, a relay server or a device serving as the obtaining source accessing the management server 3 to obtain an FW file is recorded.

In “identification number”, an identification number such as an apparatus identification (ID) or a device ID for uniquely identifying a relay server 4 or a device 2 is recorded. It is assumed that the identification numbers of the relay servers 4A and 4B are 11 and 12, respectively, and the identification numbers of the devices 2A, 2B, 2C, and 2D are 051, 052, 053, and 054, respectively. In FIG. 5, the state in which the relay server 4A and the devices 2C, 2D, and the like have accessed the management server 3 is illustrated.

In “model number”, a model number for identifying the type of a device 2 to which firmware is applied is recorded. In FIG. 5, because the devices 2C and 2D have different model numbers, it is clear that the devices 2C and 2D are of different models. It is also clear that the relay server 4A has downloaded an FW file for the same model as the device 2C. Besides a model number, model identification information such as a model name may be used.

In “file type”, identification information of a file (such as a file identification code) is recorded. A version is added to firmware, and the entity of an FW file is held and managed in the management server 3. In “version”, the version number of firmware is recorded. The version number is an example of version information. In “file size”, the file size of an FW file is recorded. In “access source IP address”, the IP address of the obtaining source accessing the management server 3 is recorded.

FIG. 6 is a diagram illustrating an example of the management information table 312 held by the management server 3. The management information table 312 includes a plurality of items such as “model number”, “file type”, “version”, and “update date and time”. Management information is information including these items. In “update date and time”, the date and time of an inquiry from a device 2 as to whether there is an FW file that should be updated is recorded. The meanings of the other items are the same as those of the communication log information table 311 illustrated in FIG. 5, and descriptions thereof are thus omitted. Depending on whether there are optional parts (such as a finisher and a billing device) of each device 2, an FW file may change. Thus, these items of information may also be included in the management information table 312.

### Configuration of Relay Server

FIG. 7 is a block diagram illustrating an example of a control system of each relay server 4. The relay server 4 includes a controller 40, which controls each unit of the relay server 4. A memory 41, an input unit 42 realized by a keyboard, a mouse, and the like, a display 43 realized by a liquid crystal display or the like, and a communication unit 44 which communicates with the management server 3, the devices 2, and the like via the network 5 are connected to the controller 40.

The controller 40 includes a processor such as a CPU, an interface, and the like. By executing a program stored in the memory 41, the controller 40 obtains communication log information from the management server 3, sends FW files stored in the memory 41 to the devices 2, and records and registers information in a communication log information table 411 and a management information table 412.

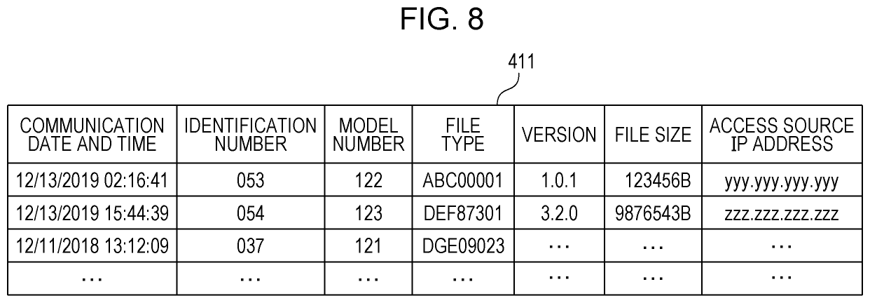

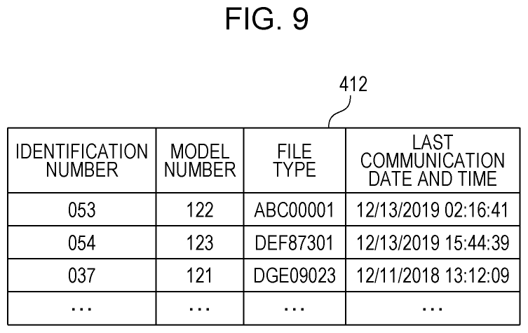

The memory 41 includes ROM, RAM, a hard disk drive, and the like, and stores various types of information including programs, FW files, the communication log information table 411 (see FIG. 8), the management information table 412 (see FIG. 9), access source region conversion information 413, and management region information 414.

In the access source region conversion information 413, rules for converting the access source IP address, which identifies the access source, by city, town, village, prefecture, area, and/or country are recorded.

In the management region information 414, information indicating a region managed by the relay server 4 is recorded. The region is allocated by, for example, the administrator who manages the information processing system 1, the management server 3, or the relay server 4, and includes a place where a device 2 managed by the relay server 4 is installed. The region may be, for example, in units of prefectures, or in units of areas such as Kanto area and Tohoku area. In addition, the region may or may not include a place where the relay server 4 is installed. Furthermore, preferably the region does not overlap, but may overlap, a region managed by another relay server 4.

FIG. 8 is a diagram illustrating an example of the communication log information table 411 held by each relay server 4. The communication log information table 411 includes a plurality of items such as “communication date and time”, “identification number”, “model number”, “file type”, “version”, “file size”, and “access source IP address”. The meanings of these items are the same as those of the communication log information table 311 illustrated in FIG. 5, and descriptions thereof are thus omitted. The communication log information table 411 illustrated in FIG. 8 is different from the communication log information table 311 illustrated in FIG. 5 in the point that communication log information whose obtaining type is a relay server is not recorded.

FIG. 9 is a diagram illustrating an example of the management information table 412 held by each relay server 4. The management information table 412 includes a plurality of items such as “identification number”, “model number”, “file type”, and “last update date and time”. In “last update date and time”, the date and time at which a device 2 or the relay server 4 accessed the management server 3 is recorded. The meanings of the other items are the same as those of the communication log information table 311 illustrated in FIG. 5, and descriptions thereof are thus omitted.

Next, the controller 40 of each relay server 4 will be described.

Using IP Geolocation technology using IP addresses, the controller 40 identifies a region to which the IP address of the obtaining source of an FW file included in communication log information belongs, and determines whether the region is under control of the relay server 4. Specifically, when the controller 40 determines that the region to which the IP address belongs belongs to information of a region under control of the relay server 4, which is stored in the memory 41, the controller 40 registers management information corresponding to the IP address in the management information table 412.

In the case where the region to which the IP address belongs is undeterminable from the IP address, the controller 40 may determine that the region is under control of the relay server 4 and register the management information in the management information table 412. Only the communication log information of a device 2 registered in the management information table 412 may be synchronized with the management server 3.

In addition, the controller 40 inquires of the management server 3 whether there is an FW file that should be downloaded by, among all the devices 2 managed by the management server 3, a device 2 whose communication is relayed by the relay server 4 to the management server 3, for the same model as the device 2 whose communication is relayed. Specifically, the controller 40 obtains communication log information from the management server 3, and extracts, from the obtained communication log information, the communication log information of the device 2 whose communication is relayed and the identification number, model number, and so forth of the device 2. Communication log information is an example of history information.

The controller 40 determines a device 2 whose communication is relayed by the relay server 4 on the basis of the IP address of each device 2 included in the communication log information. That is, the controller 40 determines a device 2 whose communication is relayed by the relay server 4 on the basis of the model number of each device 2 included in the communication log information. In this case, the controller 40 may determine a device 2 whose communication is relayed by the relay server 4 so as not to overlap with the model of a device 2 whose communication is relayed by another relay server 4.

As a result of inquiring of the management server 3, if there is a new version of a program as a corresponding FW file, the controller 40 obtains difference information between the new version of the program and an old version of the program from the management server 3, stores the difference information in the memory 41, and, in response to an inquiry from a device 2 under control of the relay server 4, allows the device 2 to download the difference information.

In addition, if there is no inquiry from a device 2 under control of the relay server 4 for a predetermined period, the controller 40 excludes the device 2 from the range of devices 2 whose communication is relayed by the relay server 4. Specifically, the controller 40 deletes information regarding the device 2 from the communication log information table 411 and the management information table 412.

### Operation of Information Processing System

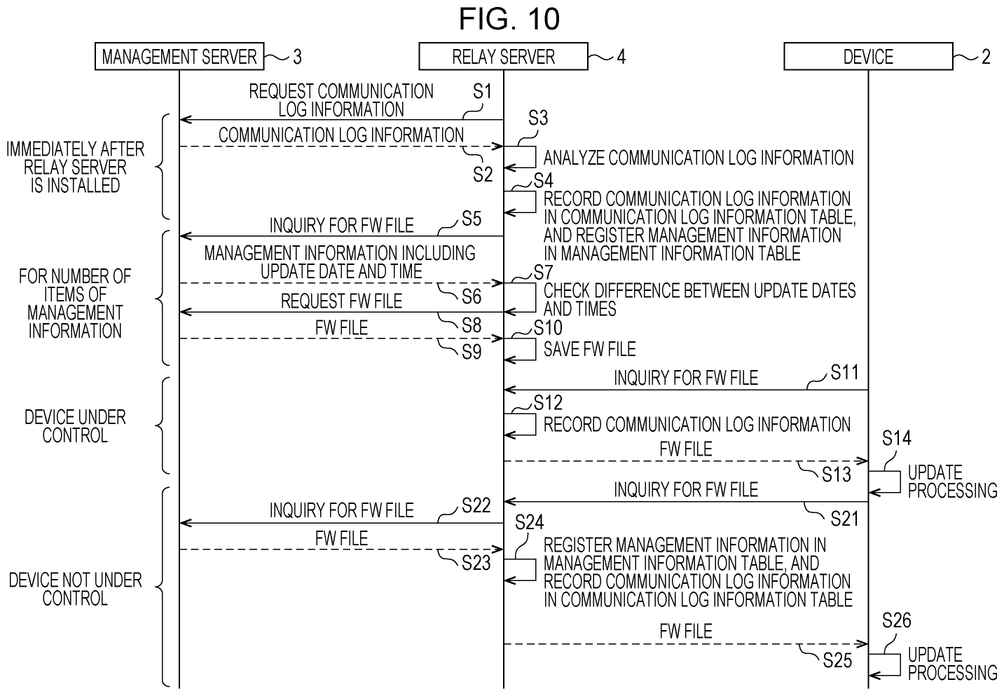

Next, an example of the operation of the information processing system 1 will be described with reference to the sequence diagram illustrated in FIG. 10. Note that the case in which the relay server 4A is already installed, and then the relay server 4B is installed will be described.

### (1) Immediately After the Relay Server 4B is Installed

In response to detection that the relay server 4B has been newly installed, the controller 40 of the relay server 4B accesses the management server 3 to request communication log information for a predetermined period (such as the last year) (S1), and obtains the communication log information from the management server 3 (S2).

The controller 40 analyzes the obtained communication log information (S3). That is, the controller 40 converts an access source IP address whose obtaining type included in the communication log information table 311 illustrated in FIG. 5 is a device to a region using the access source region conversion information 413, and extracts, from the communication log information obtained in step S2, only the communication log information of a device 2 in which the resultant region is included in the management region information 414.

Next, the controller 40 records the extracted communication log information in the communication log information table 411 as illustrated in FIG. 8, and, of the communication log information illustrated in FIG. 8, registers management information including the identification number, the model number, the file type, and the communication date and time in the management information table 412 (S4). At this time, the communication date and time is recorded in “last communication date and time”. Whereas the identification numbers 053 and 054 illustrated in FIG. 9 correspond to the devices 2C and 2D illustrated in FIG. 2, the region of the device 2E (not illustrated) with the identification number 037 is undeterminable from the IP address. Thus, the device 2E is regarded to be under control of the relay server 4B, and accordingly management information thereof is recorded in the management information table 412.

### (2) Processing for the Number of Items of Management Information

The controller 40 of the relay server 4B inquires of the management server 3 whether there is an FW file that should be updated (S5). The inquiry includes all the model numbers recorded in the management information table 412 of the relay server 4. The management server 3 refers to the management information table 312 held by the management server 3, and, if there is an FW file that should be updated (e.g., the update date and time is within the last few months) for the model numbers, sends management information including the update date and time to the relay server 4. The relay server 4 obtains the update date and time from the management information (S6).

The controller 40 refers to the management information table 412 and checks the difference between the received update date and time and the update date and time recorded as the last communication date and time (S7).

If there is a difference between the two update dates and times, the controller 40 requests an FW file from the management server 3 (S8), downloads the FW file (S9), and stores the FW file in the memory 41 (S10). For example, for an FW file that should be updated whose file type is ABC00001, if the obtained update date and time is later than 12/13/2019 02:16:41, which is the last communication date and time, the controller 40 obtains an FW file whose file type is ABC00001.

### (3) Device Under Control

The controller 20 of each of the devices 2C and 2D inquires of the relay server 4B, which controls the devices 2C and 2D, whether there is an FW file that should be updated (S11). The inquiry includes an identification number and a model number. At this time, the controller 40 of the relay server 4B records communication log information in the communication log information table 411 (S12). The controller 40 records communication log information in the communication log information table 411 whenever the controller 40 receives an inquiry for an FW file from each device 2.

The controller 20 of each of the devices 2C and 2D downloads the FW file from the relay server 4B as a response to the inquiry, and stores the FW file in the memory 21 (S13). The controller 20 performs a process of updating the FW file stored in the memory 21 (S14). When the updating process is completed, the controller 20 sends an update completion report to the relay server 4B.

### (4) Device not Under Control

It is assumed that the device 2F (not illustrated) is not under control of the relay server 4B. The controller 20 of the device 2F inquires of the relay server 4B whether there is an FW file that should be updated (S21). The inquiry includes an identification number and a model number.

Since the device 2F is not registered in the management information table 412, the controller 40 of the relay server 4B determines that the inquiry is from a device 2 not under control of the relay server 4B, inquires of the management server 3 whether there is an FW file for the device 2F (S22), and downloads the FW file from the management server 3 (S23). As a result of inquiring of the management server 3, if there is no FW file that should be updated, the controller 40 sends a report indicating that the update is unnecessary to the device 2F.

The controller 40 of the relay server 4B registers management information regarding the device 2F in the management information table 412, and records communication log information regarding the device 2F in the communication log information table 411 (S24).

The controller 20 of the device 2F downloads the FW file from the relay server 4B as a response to the inquiry, and stores the FW file in the memory 21 (S25). The controller 20 performs a process of updating the FW file stored in the memory 21 (S26). When the updating process is completed, the controller 20 sends an update completion report to the relay server 4B.

In response to detection from the communication log information that there has been no communication from a device 2 recorded in the management information table 412 for a predetermined period (such as the last year), the controller 40 of the relay server 4B deletes management information of the device 2 from the management information table 412, and deletes communication log information of the device 2 from the communication log information table 411. In the case of the device 2E with the identification number 037 and the model number 121 in the management information table 412 illustrated in FIG. 9, the last communication date and time is 12/11/2018 13:12:09, and there has been no access from the device 2E for the last year, the controller 40 deletes the management information and communication log information of the device 2E.

### First Modification

Although each device 2 inquires of a corresponding one of the relay servers 4 and downloads an FW file as a response to the inquiry from the relay server 4 in the above-described exemplary embodiment, the relay server 4 may notify each device 2 that there is an FW file that should be updated using a push notification, and, on the basis of this, the device 2 may download the FW file from the relay server 4. In this case, it becomes unnecessary for each device 2 to periodically inquire of a corresponding one of the relay servers 4.

Although the exemplary embodiment of the present disclosure has been described above, the exemplary embodiment of the present disclosure is not limited to the above-described exemplary embodiment, and various modifications may be implemented.

Some (one or more) or all of the units of the processor may be set up by a hardware circuit such as a field-programmable gate array (FPGA) or an application-specific integrated circuit (ASIC).

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

In addition, one or some of the elements in the above-described exemplary embodiment may be omitted or changed. In addition, one or more steps may be added, deleted, changed, or replaced in the flow of the exemplary embodiment. In addition, a program used in the above-described exemplary embodiment may be recorded on a computer-readable recoding medium such as a compact-disc read-only memory (CD-ROM) and provided, or may be stored in an external server such as a cloud server and used via a network.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A relay apparatus comprising:
a processor configured to inquire of a management apparatus that manages control information used by a plurality of devices whether there is control information that should be downloaded by, among the plurality of devices, a device whose communication is relayed by the relay apparatus to the management apparatus, for a same model as the device whose communication is relayed.

2. The relay apparatus according to claim 1, wherein the processor is configured to obtain, from the management apparatus, history information of access from the plurality of devices to the management apparatus, and, based on the obtained history information, extract history information of the device whose communication is relayed and information of a model of the device.

3. The relay apparatus according to claim 2, wherein the processor is configured to determine the device whose communication is relayed based on an Internet Protocol (IP) address of the device included in the obtained history information.

4. The relay apparatus according to claim 2, wherein the processor is configured to determine the device whose communication is relayed based on information of a model of the device included in the obtained history information.

5. The relay apparatus according to claim 4, wherein the processor is configured to determine the device whose communication is relayed so as not to overlap with a model of a device whose communication is relayed by another relay apparatus.

6. The relay apparatus according to claim 1, wherein the processor is configured to
in a case where, as a result of the inquiry, there is a new version of a program as corresponding control information, obtain difference information between the new version of the program and an old version of the program from the management apparatus, and store the difference information in memory, and
allow the device to download the difference information.

7. The relay apparatus according to claim 2, wherein the processor is configured to
in a case where, as a result of the inquiry, there is a new version of a program as corresponding control information, obtain difference information between the new version of the program and an old version of the program from the management apparatus, and store the difference information in memory, and
allow the device to download the difference information.

8. The relay apparatus according to claim 3, wherein the processor is configured to
in a case where, as a result of the inquiry, there is a new version of a program as corresponding control information, obtain difference information between the new version of the program and an old version of the program from the management apparatus, and store the difference information in memory, and
allow the device to download the difference information.

9. The relay apparatus according to claim 4, wherein the processor is configured to
in a case where, as a result of the inquiry, there is a new version of a program as corresponding control information, obtain difference information between the new version of the program and an old version of the program from the management apparatus, and store the difference information in memory, and
allow the device to download the difference information.

10. The relay apparatus according to claim 5, wherein the processor is configured to
in a case where, as a result of the inquiry, there is a new version of a program as corresponding control information, obtain difference information between the new version of the program and an old version of the program from the management apparatus, and store the difference information in memory, and
allow the device to download the difference information.

11. The relay apparatus according to claim 6, wherein the processor is configured to allow the difference information to be downloaded in response to an inquiry from the device whose communication is relayed.

12. The relay apparatus according to claim 7, wherein the processor is configured to allow the difference information to be downloaded in response to an inquiry from the device whose communication is relayed.

13. The relay apparatus according to claim 8, wherein the processor is configured to allow the difference information to be downloaded in response to an inquiry from the device whose communication is relayed.

14. The relay apparatus according to claim 9, wherein the processor is configured to allow the difference information to be downloaded in response to an inquiry from the device whose communication is relayed.

15. The relay apparatus according to claim 10, wherein the processor is configured to allow the difference information to be downloaded in response to an inquiry from the device whose communication is relayed.

16. The relay apparatus according to claim 11, wherein the processor is configured to exclude the device whose communication is relayed from a range of devices whose communication is relayed in a case where there is no inquiry from the device for a predetermined period.

17. The relay apparatus according to claim 12, wherein the processor is configured to exclude the device whose communication is relayed from a range of devices whose communication is relayed in a case where there is no inquiry from the device for a predetermined period.

18. The relay apparatus according to claim 13, wherein the processor is configured to exclude the device whose communication is relayed from a range of devices whose communication is relayed in a case where there is no inquiry from the device for a predetermined period.

19. The relay apparatus according to claim 14, wherein the processor is configured to exclude the device whose communication is relayed from a range of devices whose communication is relayed in a case where there is no inquiry from the device for a predetermined period.

20. A non-transitory computer readable medium storing a program causing a computer to execute a process, the process comprising:
inquiring of a management apparatus that manages control information used by a plurality of devices whether there is control information that should be downloaded by, among the plurality of devices, a device whose communication is relayed to the management apparatus, for a same model as the device whose communication is relayed.
